(19) United States
(12) Patent Application Publication
(10) Pub. No.: US 2022/0028066 A1
(43) Pub. Date: Jan. 27, 2022

(54) SYSTEM AND METHOD FOR OBTAINING MEASUREMENTS FROM IMAGING DATA

(71) Applicant: Voxeleron, LLC, San Francisco, CA (US)

(72) Inventors: Jonathan D. Oakley, Pleasanton, CA (US); Daniel B. Russakoff, Pleasanton, CA (US)

(21) Appl. No.: 17/299,523

(22) PCT Filed: Dec. 6, 2019
(86) PCT No.: PCT/US2019/064993

§ 371 Date: Jun. 3, 2021

Related U.S. Application Data
(60) Provisional application No. 62/777,691, filed on Dec. 10, 2018.

(51) Int. Cl. G06T 7/00; G06T 7/12

(52) U.S. Cl. CPC G06T 7/0012; G06T 7/12; G06T 2207/20076; G06T 2207/10101; G06T 2207/30041

(57) ABSTRACT

Probabilistic measurements of objects in image data are obtained by analyzing individual segments of an image to determine the probability that an object is present in the segment, and aggregating the total probabilities among all of the segments in the image to provide an overall probabilistic measurement of the object. For example, pixels of an OCT image can be assigned probabilities that the pixel contains a retinal layer or background. The sum of probabilities of the retinal layer being present in a one-dimensional row of pixels gives a probabilistic length in that dimension of the retinal layer. Likewise, the sum of a two-dimensional array of pixels gives an area; and a three-dimensional array gives a volume.

### RELATED APPLICATION

This application claims the benefit of and priority to U.S. Provisional Application Ser. No. 62/777,691, filed Dec. 10, 2018, the contents of which are incorporated by reference in their entirety.

### FIELD OF THE INVENTION

The present disclosure generally relates to image analysis and interpretation, and particularly relates to obtaining measurements of objects in image data using probabilistic analysis of image segments.

### BACKGROUND

Many diseases manifest themselves through changes in retinal health and can be diagnosed using optical coherence tomography (OCT) imaging of the retina. An OCT scanner creates depth-resolved image data that can reveal near-cellular detail. The axial resolution of most scanners is in a range of the order of 5 microns, which renders various retinal layers visible, allowing them to be measured accurately. Some ocular pathologies can be diagnosed based on the thicknesses of retinal layers or based on morphological changes seen in the OCT images.

Some examples of diseases that can be assessed through retinal analysis are age-related macular degeneration (AMD) and multiple sclerosis (MS). AMD proceeds in distinct stages from early, to intermediate, to advanced, resulting in irreversible damage to the photoreceptors and vision loss. Likewise, MS progresses through various states of relapse remitting MS (RRMS), primary and secondary progressive, and progressive relapsing. Such clinically defined stages can be followed based on biomarkers that include layer thicknesses of the retina. In general, clinical outcomes for AMD, MS, and other diseases could be improved with tools providing more accurate retinal measurements, as small differences in retinal thickness can be clinically important, and therefore it is important to be able to obtain accurate measurements of objects imaged using OCT.

### SUMMARY

The present disclosure provides probabilistic techniques for obtaining measurements of objects in image data. In accordance with the invention, image data is segmented into pixels or other segments, and each segment is analyzed to determine the probability that an object is present in the segment. Probabilities are assigned to each segment based on its likelihood of belonging to each of the various classes of objects in the data. The probabilities for a given length, area, or volume are then aggregated to provide a total which represents the overall probabilistic measurement of the object. For example, pixels of an OCT image can be assigned probabilities that the pixel contains a retinal layer or background. The sum of probabilities of the retinal layer being present in a one-dimensional row of pixels gives a probabilistic length in that dimension of the retinal layer. Likewise, the sum of a two-dimensional array of pixels gives an area; and a three-dimensional array gives a volume.

Aspects of the invention involve a method for measuring an object in an image. The method involves segmenting an image into a plurality of segments. The method further involves obtaining a probabilistic value for each of the plurality of segments, wherein the probabilistic value corresponds to a likelihood of an object being in each of the plurality of segments. The method further involves aggregating the probabilistic values from the plurality of segments to obtain a measurement for the object.

In certain embodiments, the image comprises multiple classes of objects. The method may involve obtaining probabilistic values for each of the multiple classes of objects. The multiple classes of objects may include one or more of: a retinal layer, a fluid pocket, and background.

In some embodiments, the image is an OCT image. In some embodiments, the plurality of segments are pixels. In some embodiments, the probabilistic values are used to measure distances, areas, volumes, or volumes over time. In some embodiments, the probabilistic values are between 0 and 1, inclusive. In some embodiments, the probabilistic values are generated using a deep learning algorithm or a fuzzy clustering algorithm.

In related aspects, the disclosure provides a system for measuring an object in an image. the system includes a processor operably coupled to a memory. The processor is configured to analyze a plurality of segments of an image to determine a probabilistic value corresponding to a likelihood of an object being present in the segment aggregate the probabilistic values from the plurality of segments to generate a measurement of the object.

In embodiments, the image includes multiple classes of objects. The processor may be further configured to determine probabilistic values for each of the multiple classes of objects. In some embodiments, the multiple classes of objects include a retinal layer, a fluid pocket, or background.

In some embodiments, the image is an OCT image. In some embodiments, the plurality of segments are pixels. In some embodiments, the probabilistic values are used to measure distances, areas, volumes, or volumes over time. In some embodiments, the probabilistic values are between 0 and 1, inclusive. In some embodiments, the processor is configured to run a deep learning algorithm or a fuzzy clustering algorithm to determine the probabilistic values. In some embodiments, the system further includes an imaging apparatus operably connected to the processor.

### BRIEF DESCRIPTION OF THE DRAWINGS

FIG. 1 shows an OCT image and a corresponding partition based on layer segmentation.

FIG. 2 shows an OCT image and a corresponding partition based on layer segmentation using a different method.

FIG. 3 is a chart showing probabilistic labeling of pixels in a 1-by-7 pixel image.

FIG. 4 is a chart showing labeling of pixels without probabilistic labeling.

FIGS. 5 and 6 show an OCT image of fluid and corresponding partitions based on layer segmentation.

FIG. 7 shows a system architecture compatible with the invention.

### DETAILED DESCRIPTION

The disclosure relates to an image analysis method that can be used to make measurements that relate to distances, areas, and volumes within an image, in particular for measuring objects seen in the image. The object of interest is segmented in some way such that each picture element (pixel) is assigned a probability of belonging to the object or not. This is a method of image segmentation that is used in many applications. But instead of explicitly measuring that object, the disclosed methods obtain a sum of probability scores as a means of performing the measurement.

The disclosure provides a reporting metric for class-related measurements. Methods involve first accessing a data set containing one or more classes, and generating class probabilities for each element in the data set. Measurements are calculated by combining the probabilities of each class over all elements in the data set. The measurement is thus reported based on the probability of the relevant classes. Class probabilities can be combined in various ways, such as by using the arithmetic mean, the geometric mean, or the median. Measurements can be one-dimensional distances, two-dimensional areas, or three-dimensional volumes, or any of these taken over time. The measurement can be of a retinal fluid pocket or retinal layer thickness using OCT data. Fluid pockets can be measured as two-dimensional areas or three-dimensional volumes. The class probabilities can be generated using, for example, a neural network or fuzzy clustering.

Ocular and other pathologies can be assessed based on morphological markers in the retina, which are observable with optical coherence tomography (OCT) imaging. The present disclosure describes methods for analyzing OCT data to provide earlier and more accurate assessments and prognoses of retinal health. The application is particularly useful for measuring one or more layers of the retina in OCT image data, but it is to be understood that the methods can be used to measure any object in any image.

In a particular example discussed herein, the methods are useful for assessing age-related macular degeneration (AMD) in a patient, and determining whether the patient will develop the disease, or will progress from early/intermediate AMD to advanced AMD. It is to be understood that methods of the disclosure allow the assessment of a variety of pathologies that manifest themselves in the retina. It should be understood that any disease involving changes to the retina can be assessed with the methods of the invention, including diseases that are not strictly ocular diseases.

Traditionally OCT analysis involves observing recognizable structures, such as the inner and outer retinal boundaries, and measuring the thickness in between. Some methods involve observing the volume, height, and reflectivity of drusen, or the thinning and loss of reflectivity of the inner/outer segment junction. A thinning retinal layer could be indicative of atrophy, whereas thickening could be blood leakage or neovascularization, the degree of which may be measured as a thickness, area, or volume. Neovascularization is typically diagnosed based on signs of exudation, seen either by fundus examination and confirmed using fluorescein angiography or by visualizing fluid pockets seen cross-sectionally using depth resolved OCT images; such fluid pockets having the effect of thickening the retina.

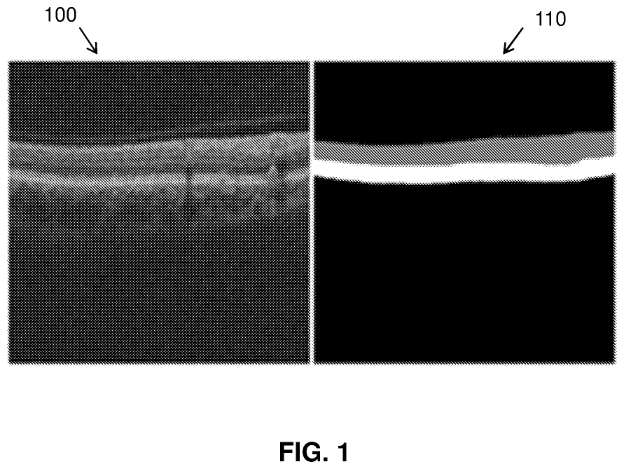

FIG. 1 shows an OCT image 100 of the human retina and a partition 110 of the image based on layer segmentation. Key components of the retina are labeled based on an automated segmentation using deep learning. A fully-automated segmentation algorithm has accurately delineated interfaces between layers of the retina (retinal layer segmentation). The following labels have been assigned: 0 (background); 1 (inner retina); 2 (outer retina). This labelling is based on a supervised learning approach.

Such technologies are used clinically as the thickening and/or thinning of certain retinal layers relates very directly to various pathologies. The eye is an extension of the central nervous system (CNS), so the clinical use of such technology is not limited to the detection and management of ocular pathologies.

Central to the clinical utility of retinal layer segmentation is the reporting mechanism. Thicknesses of layers are generally reported as absolute values (typically in microns given the thickness of a healthy retina is on the order of ˜300 μm). For a two-dimensional image, this thickness would be reported as a one-dimensional profile; for a three-dimensional volume, it would typically be reported as a thickness map (a two-dimensional representation of the thickness). They can also be reported in sectors relative to the macula, for example.

Traditional computer vision techniques define the layers based on, for example, horizontal edges, and are designed to create a set of partitions of the data where pixels are assigned a single label. Software is available that draws lines in the data at the interfaces such that pixels are grouped with a label associated to which side of the line they sit. Techniques are described, for example, in WO 2019/029160, incorporated by reference herein. Delineating interfaces in this way ensures that each label is connected as the layers or lines that are drawn are continuous. A clustering approach, for example, might assign a label to each pixel based on its intensity, but this would not ensure the labels were connected. So the more traditional approach is ideal for measuring layer thicknesses in OCT data, as is used in clinical application.

FIG. 1 shows an input OCT image 100 on the left and a final classification image 110 on the right. The supervised deep-learning approach started by assigning a probability of membership in one of the three labels (background, inner retina, or outer retina) and converted these to final, crisp, assignments (hence the image on the right is made up of just three different grayscales). The probability is represented by a number in the range of 0 to 1. In this example of three labels, each pixel location gets assigned three values that sum to 1 giving memberships to each label. The partition 110 takes the example output and assigns a “crisp” label based on the highest association. The probability is the output of the softmax layer in a neural network, but other techniques such as fuzzy clustering work in a similar way. Thresholding is the final step that creates the crisp, unambiguous labelling.

As with most of these algorithms the class associations, or labels, are in the range 0 to 1, they are treated as probabilities. There may be two or more classes for a given segmentation task, pertaining to two or more objects of interest. These could be different layers in retinal images, as we have seen, or any different anatomical structure in an image.

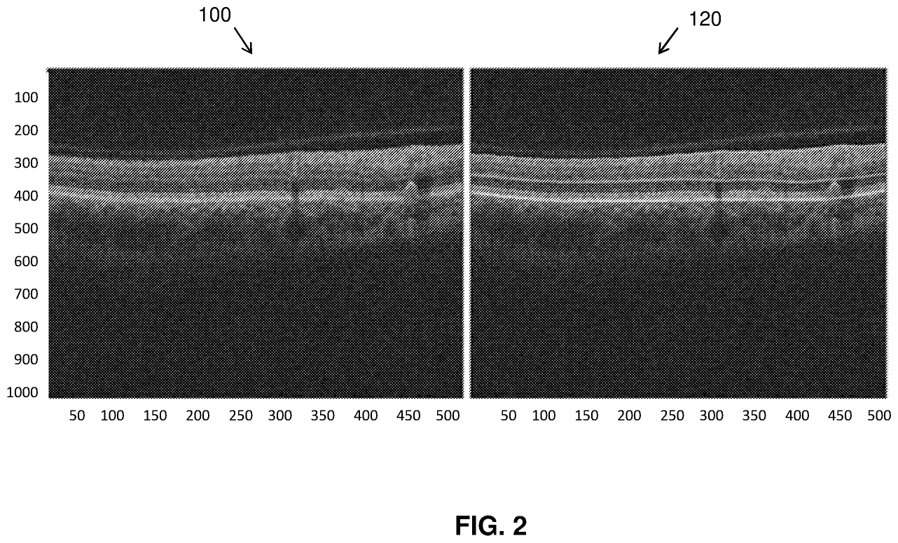

FIG. 2 shows another partition of the image 100. Partition 120 is based on layer segmentation, but here using a traditional approach of finding horizontal edges in the data and partitioning the image such that thicknesses can be precisely measured between the layers.

In traditional approaches errors can arise in thresholding or in ensuring that the labels are connected components. Unlike traditional approaches, the present disclosure provides systems and methods for reporting on thicknesses (1d distances), areas (2d) and volumes (3d) based on a summation of the probabilities rather than first converting them to absolute “crisp” associations, ensuring they are connected, and then measuring the distances, areas, and volumes. By reporting thickness, area, and volume measurements based on probabilities, the present methods simplify the measurement processing and help to avoid those errors. The methods potentially offer greater accuracy as the method is sub-pixel; i.e., at a finer granularity.

Due to the simplicity of the disclosed approach, the measurements are not prone to errors associated with either constraints that ensure labels have an associated hierarchy (ordering) and connectivity, or post-processing metrics that threshold and select connected components to ensure this. It instead trusts the ability of networks to understand patterns and organization in data over multiple scales, thereby putting faith in these methods. It also offers sub-pixel assessment of the metrics, as, for example, the thicknesses of the labels 0, 1 and 2 are not discrete, integer values in accordance to this method.

This idea solves in a simple way the translation of a probabilistic result to a metric. In arguing that it is not necessary to report such measurements as integer values (in accordance to the dimensionality of the data), the solution is to use the probabilistic results directly. Pixels (and voxels, etc.) are, after all, discrete representations of continuous, real life signals. A “crisp” association of a pixel with a label is not always indicative of reality and, indeed, can be misleading.

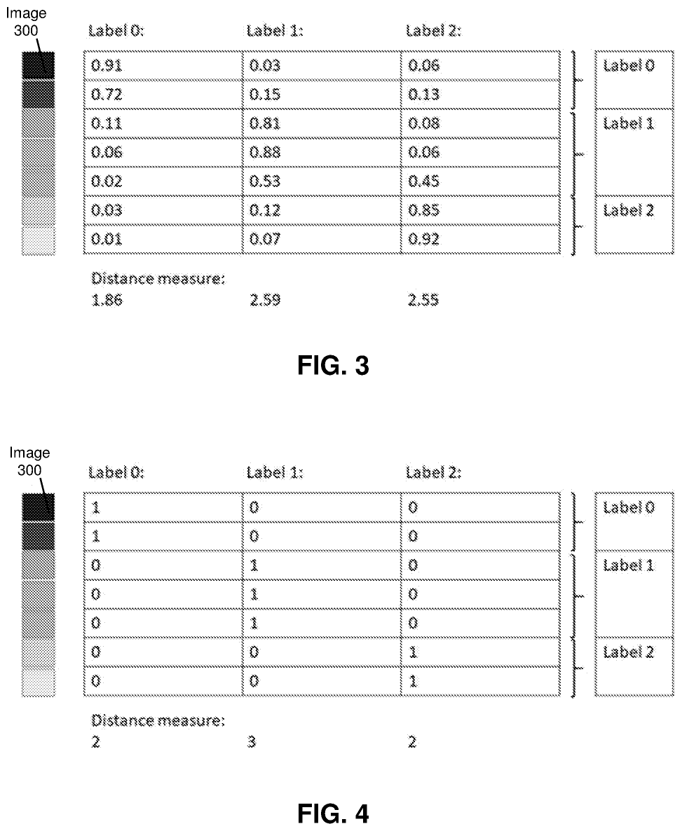

An example of a segmentation result is given in FIG. 3, which shows an image 300 on the left which is 1 pixel wide and 7 pixels deep. Using probabilistic labeling, each pixel is given three values corresponding to class associations. These values can be generating using a deep learning or fuzzy clustering algorithm. The results are shown in the table in FIG. 3. The thickness of layers 0, 1, and 2 (labeled 0, 1, and 2, respectively). The probabilistic result for each pixel is given in the table, showing the probability of the pixel corresponding to each label. Each row therefore sums to 1. The sum of each column, corresponding to the total for each label, is indicated at the bottom. A single column is the single image column's association to a single label, i.e., the thickness of a layer. These can be added to provide a measure of all of the column's association to a given label. This can be used, in this instance, as a surrogate measure of the depth of a label. A “crisp” classification is given on the right, indicating that layer 0 is two pixels deep; layer 1 is three pixels deep; and layer 2 is two pixels deep. But by using the disclosed method, the summation at the bottom of the table indicates that layer 0 is 1.86 pixels; layer 1 is 2.59 pixels; and layer 2 is 2.55 pixels. This same concept generalizes to more dimensions (area, volume, volume over time, etc.).

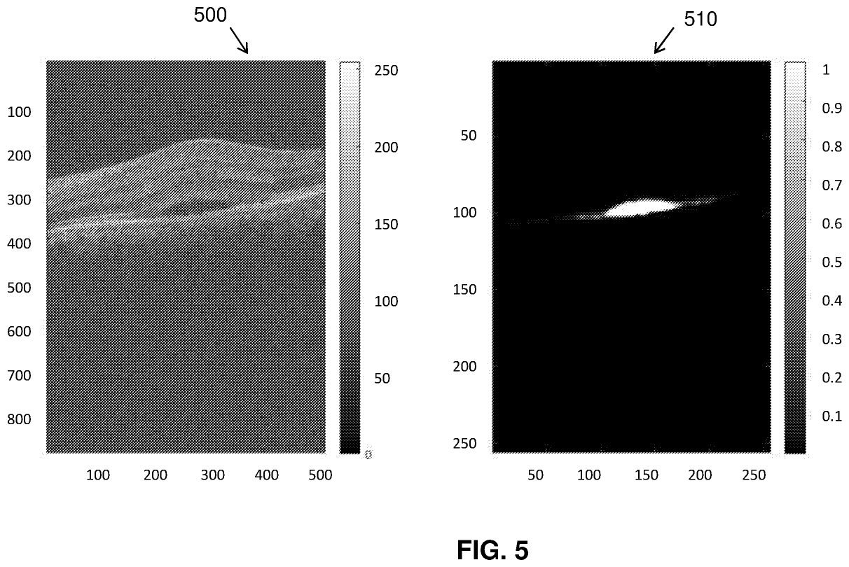

The more traditional approach is shown in FIG. 4. The image 300 is analyzed using crispy defined labels, and the distance measure is recorded based on the number of pixels. The distances are thus given as a whole number. In FIG. 4, borderline cases are assigned to one label or the other, perhaps erroneously.

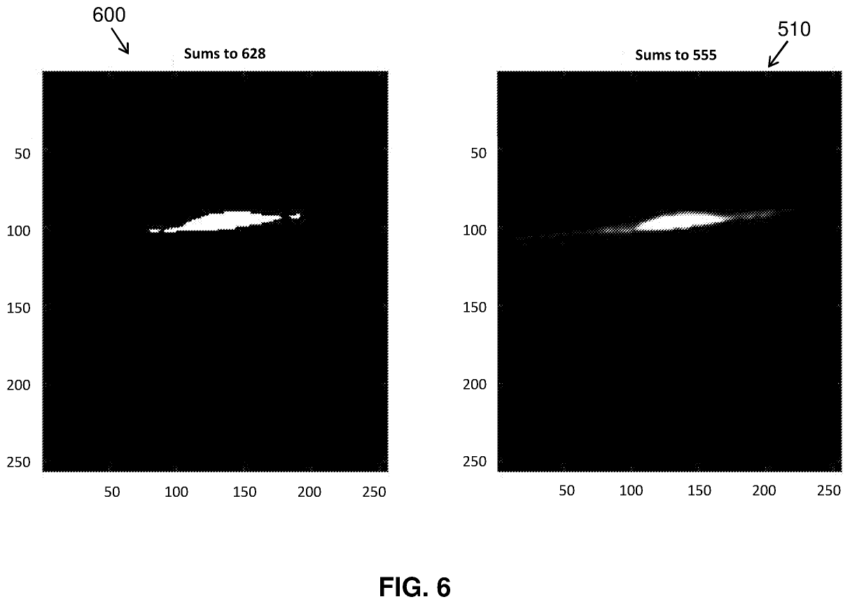

FIGS. 5 and 6 show example results where the object of interest is a fluid area. The example shows a two-dimensional image with two classes, namely (1) fluid and (2) background. FIG. 5 shows an original OCT retinal image 500 and an example fluid segmentation image 510 using a neural network. Each pixel in the resulting segmentation image 510 is a value in the range 0 to 1, where 1 indicates certainty of fluid (shown as white) and 0 certainty of not being fluid (shown as black). In this example, a quantifiable result is the area of fluid as this is of interest clinically. In general, where there is high confidence of the fluid pocket, the scores approach 1. The area metric can be derived based on a summation of all probabilities in the result image as an area measure.

FIG. 6 shows the traditional post-processing approach compared to the probabilistic approach. The traditional approach is represented by the binary image 600, which provides a crisply defined area for the retinal fluid pocket. Image 600 thresholds the probabilistic result to give us a binary image of fluid pockets. The traditional approach simply involves counting the number of pixels, which in this case is 628 pixels. The result is very dependent on how effective the thresholding is. Avoiding the need to threshold, one can more simply sum the probabilities reported in the image 510 (the probabilistic segmentation result) and get a similar number, which in this case is 555 pixels, without the need for post-processing. In the aggregate, these results will be similar, but post-processing involves additional parameterization. The results may be even more or less similar depending on the thresholding, which adds additional complexity to the interpretation of the results.

While FIGS. 5 and 6 related to an image with just two classes (fluid and background), those of skill in the art would understand that the same analysis could apply to more than two classes, for example: (1) fluid type A; (2) fluid type B; (3) fluid type C; and (4) background.

In such an example of fluid segmentation, a traditional segmentation technique that extracts the retina could be combined with this approach, allowing, for example, the area metric to be based only on pixels in the retina.

### OCT Systems

Methods of the invention rely on OCT imaging data. In exemplary embodiments, the invention provides systems for capturing three dimensional images by OCT. Commercially available OCT systems are employed in diverse applications including diagnostic medicine, e.g., ophthalmology. OCT systems and methods are described in U.S. Pub. 2011/0152771; U.S. Pub. 2010/0220334; U.S. Pub. 2009/0043191; U.S. Pub. 2008/0291463; and U.S. Pub. 2008/0180683, the contents of each of which are hereby incorporated by reference in their entirety.

In certain embodiments, an OCT system includes a light source that delivers a beam of light to an imaging device to image target tissue. Within the light source is an optical amplifier and a tunable filter that allows a user to select a wavelength of light to be amplified. Wavelengths commonly used in medical applications include near-infrared light, for example between about 800 nm and about 1700 nm. OCT systems can also operate with other light sources such as, for example, a pulsed laser as described in U.S. Pat. No. 8,108,030, the contents of which are hereby incorporated by reference in their entirety. Newer OCT devices use light to measure blood flow. Such OCT angiography devices may also make use of this technology.

Generally, there are two types of OCT systems, common beam path systems and differential beam path systems, which differ from each other based upon the optical layout of the systems. A common beam path system sends all produced light through a single optical fiber to generate a reference signal and a sample signal whereas a differential beam path system splits the produced light such that a portion of the light is directed to the sample and the other portion is directed to a reference surface. Common beam path systems are described in U.S. Pat. Nos. 7,999,938; 7,995,210; and 7,787,127 and differential beam path systems are described in U.S. Pat. Nos. 7,783,337; 6,134,003; 6,421,164; and U.S. Pub. 2006/0241503, the contents of each of which are incorporated by reference herein in its entirety.

### System Architectures

Imaging systems for obtaining the imaging data for use with the present invention may operate in a computer environment as described below. Additionally, the algorithms that make the probabilistic determinations underlying the measurements of the present invention are generally executed on a computer processor.

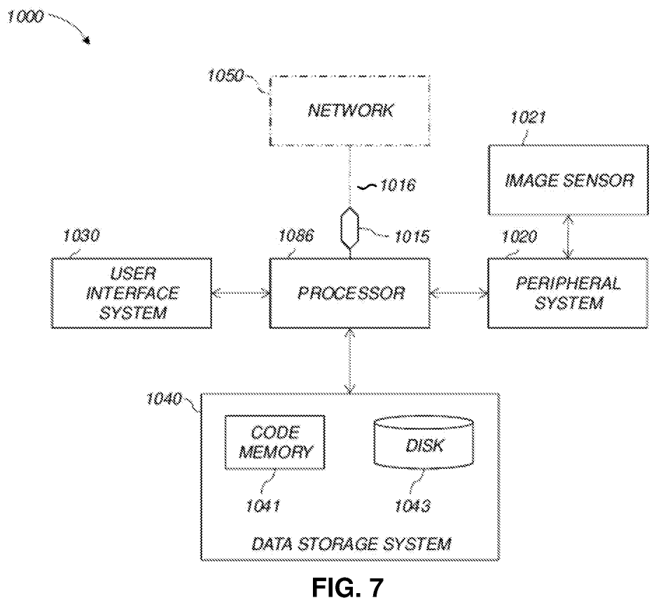

FIG. 7 is a high-level diagram showing the components of an exemplary data-processing system 1000 for analyzing data and performing other analyses described herein, and related components. The system includes a processor 1086, a peripheral system 1020, a user interface system 1030, and a data storage system 1040. The peripheral system 1020, the user interface system 1030 and the data storage system 1040 are communicatively connected to the processor 1086. Processor 1086 can be communicatively connected to network 1050 (shown in phantom), e.g., the Internet or a leased line, as discussed below. The data described above may be obtained using detector 1021 (such as an OCT instrument) and/or displayed using display units (included in user interface system 1030) which can each include one or more of systems 1086, 1020, 1030, 1040, and can each connect to one or more network(s) 1050. Processor 1086, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1086 which in one embodiment may be capable of real-time calculations (and in an alternative embodiment configured to perform calculations on a non-real-time basis and store the results of calculations for use later) can implement processes of various aspects described herein. Processor 1086 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. The phrase “communicatively connected” includes any type of connection, wired or wireless, for communicating data between devices or processors. These devices or processors can be located in physical proximity or not. For example, subsystems such as peripheral system 1020, user interface system 1030, and data storage system 1040 are shown separately from the data processing system 1086 but can be stored completely or partially within the data processing system 1086.

The peripheral system 1020 can include one or more devices configured to provide digital content records to the processor 1086. For example, the peripheral system 1020 can include digital still cameras, digital video cameras, or other data processors. The processor 1086, upon receipt of digital content records from a device in the peripheral system 1020, can store such digital content records in the data storage system 1040.

The user interface system 1030 can include a mouse, a keyboard, another computer (e.g., a tablet) connected, e.g., via a network or a null-modem cable, or any device or combination of devices from which data is input to the processor 1086. The user interface system 1030 also can include a display device, a processor-accessible memory, or any device or combination of devices to which data is output by the processor 1086. The user interface system 1030 and the data storage system 1040 can share a processor-accessible memory.

In various aspects, processor 1086 includes or is connected to communication interface 1015 that is coupled via network link 1016 (shown in phantom) to network 1050. For example, communication interface 1015 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1015 sends and receives electrical, electromagnetic or optical signals that carry digital or analog data streams representing various types of information across network link 1016 to network 1050. Network link 1016 can be connected to network 1050 via a switch, gateway, hub, router, or other networking device.

Processor 1086 can send messages and receive data, including program code, through network 1050, network link 1016 and communication interface 1015. For example, a server can store requested code for an application program (e.g., a JAVA applet) on a tangible non-volatile computer-readable storage medium to which it is connected. The server can retrieve the code from the medium and transmit it through network 1050 to communication interface 1015. The received code can be executed by processor 1086 as it is received, or stored in data storage system 1040 for later execution.

Data storage system 1040 can include or be communicatively connected with one or more processor-accessible memories configured to store information. The memories can be, e.g., within a chassis or as parts of a distributed system. The phrase “processor-accessible memory” is intended to include any data storage device to or from which processor 1086 can transfer data (using appropriate components of peripheral system 1020), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), Universal Serial Bus (USB) interface memory device, erasable programmable read-only memories (EPROM, EEPROM, or Flash), remotely accessible hard drives, and random-access memories (RAMs). One of the processor-accessible memories in the data storage system 1040 can be a tangible non-transitory computer-readable storage medium, i.e., a non-transitory device or article of manufacture that participates in storing instructions that can be provided to processor 1086 for execution.

In an example, data storage system 1040 includes code memory 1041, e.g., a RAM, and disk 1043, e.g., a tangible computer-readable rotational storage device such as a hard drive. Computer program instructions are read into code memory 1041 from disk 1043. Processor 1086 then executes one or more sequences of the computer program instructions loaded into code memory 1041, as a result performing process steps described herein. In this way, processor 1086 carries out a computer implemented process. For example, steps of methods described herein, blocks of the flowchart illustrations or block diagrams herein, and combinations of those, can be implemented by computer program instructions. Code memory 1041 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects. These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1086 (and possibly also other processors) to cause functions, acts, or operational steps of various aspects herein to be performed by the processor 1086 (or other processor). Computer program code for carrying out operations for various aspects described herein may be written in any combination of one or more programming language(s), and can be loaded from disk 1043 into code memory 1041 for execution. The program code may execute, e.g., entirely on processor 1086, partly on processor 1086 and partly on a remote computer connected to network 1050, or entirely on the remote computer.

1. A method for measuring an object in an image, the method comprising:
segmenting an image into a plurality of segments;
obtaining a probabilistic value for each of the plurality of segments, the probabilistic value corresponding to a likelihood of an object being in each of the plurality of segments; and
aggregating the probabilistic values from the plurality of segments to obtain a measurement for the object.

2. The method of claim 1, wherein the image comprises multiple classes of objects.

3. The method of claim 2, further comprising obtaining probabilistic values for each of the multiple classes of objects.

4. The method of claim 2, wherein the multiple classes of objects comprise one or more of: a retinal layer, a fluid pocket, lesion, cyst, and background.

5. The method of claim 1, wherein the image is an OCT image.

6. The method of claim 1, wherein the plurality of segments comprise pixels.

7. The method of claim 1, wherein the measurements are distances, areas, volumes, distances over time, areas over time, or volumes over time.

8. The method of claim 1, wherein the probabilistic values are between 0 and 1, inclusive.

9. The method of claim 1, wherein the probabilistic values are generated using a deep learning algorithm or a fuzzy clustering algorithm.

10. A system for measuring an object in an image, the system comprising:
a processor operably coupled to a memory, the processor configured to:
analyze a plurality of segments of an image to determine a probabilistic value corresponding to a likelihood of an object being present in the segment; and
aggregate the probabilistic values from the plurality of segments to generate a measurement of the object.

11. The system of claim 10, wherein the image comprises multiple classes of objects.

12. The system of claim 11, wherein the processor is further configured to determine probabilistic values for each of the multiple classes of objects.

13. The system of claim 10, wherein the multiple classes of objects comprise one or more of: a retinal layer, a fluid pocket, lesion, cyst, and background.

14. The system of claim 10, wherein the image is an OCT image.

15. The system of claim 10, wherein the plurality of segments comprise pixels.

16. The system of claim 10, wherein the measurements are distances, areas, volumes, distances over time, areas over time, or volumes over time.

17. The system of claim 10, wherein the probabilistic values are between 0 and 1, inclusive.

18. The system of claim 10, wherein the processor is configured to run a deep learning algorithm or a fuzzy clustering algorithm to determine the probabilistic values.

19. The system of claim 10, further comprising an imaging apparatus operably connected to the processor.
